(19) United States
(12) Patent Application Publication
(10) Pub. No.: US 2017/0092126 A1
(43) Pub. Date: Mar. 30, 2017

(54) DATA PROCESSING DEVICE AND IN-VEHICLE COMMUNICATION DEVICE

(71) Applicant: Renesas Electronics Corporation, Tokyo (JP)

(72) Inventors: Daisuke OSHIDA, Tokyo (JP); Masakatsu YOKOTA, Tokyo (JP); Yasuhiro SAGESAKA, Tokyo (JP)

(21) Appl. No.: 15/271,380

(22) Filed: Sep. 21, 2016

(30) Foreign Application Priority Data
Sep. 28, 2015 (JP) 2015-189700

(51) Int. Cl. G08G 1/0967; G08G 1/005; H04B 1/3822; G08G 1/07; H04L 12/931; H04W 4/04

(52) U.S. Cl. CPC G08G 1/096791; H04L 49/201; H04W 4/046; H04B 1/3822; G08G 1/07; G08G 1/005; H04W 84/12

(57) ABSTRACT

There is provided a communication system including the first communication device (roadside unit), a second communication device, and a data processing device. The first communication device is capable of establishing broadcast-type first communication (V2X communication) with the first communication terminal (vehicle). The second communication device is capable of establishing unicast- or multicast-type second communication with a plurality of moving objects (pedestrians) other than the first communication terminal and acquiring position information about the moving objects (pedestrians). The data processing device permits the second communication device to acquire position information about the moving objects and allows the first communication device (roadside unit) to transmit information (LDM) representative of the acquired position information about the moving objects to the first communication terminal (vehicle).

### CROSS-REFERENCE TO RELATED APPLICATIONS

The disclosure of Japanese Patent Application No. 2015-189700 filed on Sep. 28, 2015 including the specification, drawings, and abstract is incorporated herein by reference in its entirety.

### BACKGROUND

The present invention relates to a data processing device and to an in-vehicle communication device. Particularly, the present invention is preferably applicable to a data processing device included in a communication system adapted to provide road-to-vehicle and vehicle-to-vehicle communication handling pedestrian information and to an in-vehicle communication device mounted in a vehicle participating in the road-to-vehicle and vehicle-to-vehicle communication.

Use cases of a V2X (vehicle to X) communication system designed, for example, for road-to-vehicle and vehicle-to-vehicle communication of vehicles include vehicle-to-pedestrian (V2P) communication. In Japan, some Asian countries, and some US cities, human-vehicle accidents involving deaths account for approximately 50 percent of all fatal accidents. Therefore, collisions need to be prevented by establishing communication between pedestrians and vehicles in order to reduce the number of deaths caused by traffic accidents.

Disclosed in US Patent 2015/0035685 is a V2X communication system that additionally provides V2P communication directly established between vehicles and pedestrians. Various vehicle-pedestrian communication applications are defined by related-art technologies described in various documents including US Patent 2015/0035685. More specifically, operations performed when a vehicle detects the presence of a pedestrian are defined.

### SUMMARY

When US Patent 2015/0035685 was studied by the inventors of the present invention, it was found that the following problem needs to be solved.

It was found that a communication network may fail in a V2X communication system disclosed, for instance, in US Patent 2015/0035685 and adapted to provide direct communication between vehicles and pedestrians. The number of vehicles that may exist within a communication range from one communication terminal of the V2X communication system is more or less limited. However, the number of pedestrians that may exist within the same communication range is tens to hundreds of times greater than the number of vehicles. When, for instance, a large number of pedestrians carrying a V2X communication terminal attempt to establish communication at a bit city intersection crowded with pedestrians, the communication network may fail. As the V2X communication system uses a broadcast method, a large number of pedestrians may respond to a communication from one vehicle or simultaneously transmit information. Therefore, the number of communications may greatly exceed the permissible limit of the V2X communication system. As a result, a situation similar to a so-called DoS (Denial of Service) attack may arise.

A problem similar to the above may occur not only with the V2X communication system but also with all communication systems that use the broadcast method or other similar method.

Means for solving the above problem will be described below. Other problems and novel features will become apparent from the following description and from the accompanying drawings.

One aspect of the present invention is described below.

According to the one aspect of the present invention, there is provided a communication system including a first communication device, a second communication device, and a data processing device. The first communication device is capable of establishing a first communication with a first communication terminal by a broadcast method. The second communication device is capable of establishing a second communication with a plurality of moving objects other than the first communication terminal by a unicast method or a multicast method and acquiring position information about the moving objects. The data processing device is capable of permitting the second communication device to acquire the position information about the moving objects and allowing the first communication device to transmit information representative of the acquired position information about the moving objects to the first communication terminal.

The following is a brief description of an advantageous effect achievable by the above-described aspect of the present invention.

Even when there are an enormous number of moving objects (pedestrians), it is possible to prevent a disruption of the first communication (V2X communication), which is established between the first communication device (a roadside unit) and the first communication terminal (a vehicle such as an automobile) by the broadcast method.

### BRIEF DESCRIPTION OF THE DRAWINGS

FIG. 1 is a diagram illustrating an exemplary overall configuration of a communication system;

FIG. 2 is a schematic diagram illustrating an exemplary operation that is performed by the communication system to communicate with pedestrians;

FIG. 3 is a schematic diagram illustrating an exemplary operation that is performed by the communication system to communicate with a vehicle (automobile);

FIG. 4 is a diagram illustrating an exemplary operation that is performed by the communication system to create map information (LDM);

FIG. 5 is a diagram illustrating an exemplary configuration of a communication terminal carried by a pedestrian in the communication system;

FIG. 6 is a diagram illustrating an exemplary overall operation that is performed by the communication system when an emergency vehicle passes in the communication system;

FIG. 7 is a schematic diagram illustrating an exemplary operation that is performed by the communication system when an emergency vehicle approaches an intersection;

FIG. 8 is a schematic diagram illustrating an exemplary operation that is performed by the communication system in a normal state where no emergency vehicle is passing;

FIG. 9 is a schematic diagram illustrating that crossing time varies with the properties of pedestrians;

FIG. 10 is a schematic diagram illustrating an embodiment that detects the start and completion of a pedestrian's crossing; and

FIG. 11 is a schematic diagram illustrating an embodiment that transfers information about a pedestrian from one roadside unit to another.

### DETAILED DESCRIPTION

Embodiments of the present invention will now be described in detail. In all the drawings used to describe the embodiments, elements having the same functions are identified by the same reference numerals and will not be redundantly described.

### First Embodiment

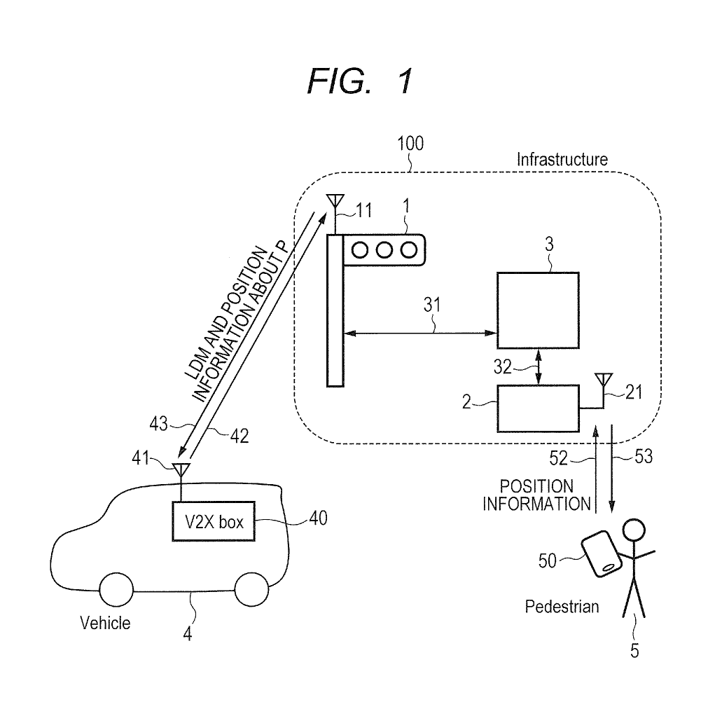

FIG. 1 is a diagram illustrating an exemplary overall configuration of a communication system. The communication system is capable of basically providing V2X communication between a vehicle (automobile) 4, a pedestrian 5, and an infrastructure 1, which includes roadside units such as a traffic light and a road sign. The infrastructure 1 is coupled to a second communication device 2 that uses a communication method different from a V2X communication method, and is adapted to communicate with a communication terminal 50 carried by the pedestrian 5. A data processing device 3 and the second communication device 2 may be physically built in the infrastructure 1 and defined as devices added to the infrastructure 1 or as functions incorporated in the infrastructure 1. The second communication device 2 may be a communication device of an existing communication system that is installed near the infrastructure 1. The infrastructure 1 is, for example, a traffic light serving as a roadside unit included in an intelligent transport system (ITS). In this instance, the second communication device is, for example, a wireless LAN (Wi-Fi (registered trademark)) or Bluetooth (registered trademark) communication device and may be a Wi-Fi or Bluetooth communication module built in the traffic light or a public wireless LAN base station independent of the ITS. In order to facilitate understanding, this document and the accompanying drawings illustrate the traffic light as an exemplary roadside unit included in the infrastructure, depict the traffic light with emphasis placed on the functionality of a communication device that establishes V2X communication with the vehicle 4, depict the data processing device 3 and the second communication device 2 as the devices coupled to the traffic light through communication paths 31, 32, and depict the combination of the traffic light, the data processing device 3, and the second communication device 2 as the communication system 100. In an embodiment where the data processing device 3 and the second communication device 2 are built in a traffic light or other roadside unit, the communication system 100 physically acts as an infrastructure. The infrastructure, the roadside unit, and the traffic light are commonly designated by the reference numeral 1 when they function as a communication device that establishes V2X communication with the vehicle 4.

A V2X communication device (V2X box) 40 coupled to an antenna 41 is mounted in the vehicle 4 to establish V2X communication with the traffic light (roadside unit) 1. The reference numeral 11 denotes an antenna for V2X communication. The reference numeral 41 denotes an uplink. The reference numeral 43 denotes a downlink.

The pedestrian 5 carries the communication terminal 50. The communication terminal 50 establishes communication with the second communication device 2 by a unicast or multicast method, which is different from the V2X communication method. It is preferred that peer-to-peer communication be established. However, one-to-many communication may alternatively be established. For example, wireless LAN (Wi-Fi) or Bluetooth communication may be established. The communication between the communication terminal 50 and the second communication device 2 need not necessarily be directly established, but may be established through a certain repeater, for example, by using a multi-hopping method. Referring to FIG. 1, the reference numeral 21 denotes an antenna coupled to the second communication device 2, and the reference numerals 52 and 53 denote an uplink and downlink for communicating with the second communication device 2.

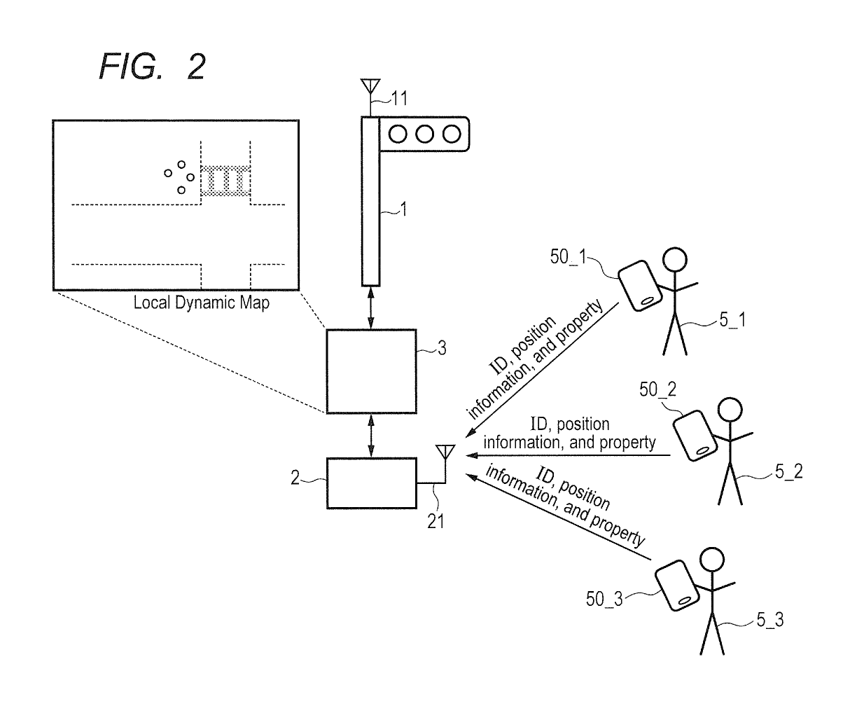

FIG. 2 is a schematic diagram illustrating an exemplary operation that is performed by the communication system to communicate with pedestrians 5. The second communication device 2 communicates with communication terminals 50_1-50_3 carried respectively by a plurality of pedestrians 5_1-5_3 to collect their identifiers (IDs), position information, and properties. As the position information varies with time, it is preferred that the associated time information be collected as well. Meanwhile, the properties need not be collected for services that do not use the properties. Pieces of position information collected individually from the pedestrians 5_1-5_3 by the second communication device 2 are integrated in the form of map information, for example, for an LDM (local dynamic map). The LDM generated in such an instance should include the IDs and position information about the pedestrians 5_1-5_3. In a more preferred embodiment, the LDM also includes the associated time information. When the LDM includes the associated time information, the communication device 40 mounted, for instance, in the vehicle (automobile) 4 adapted to periodically receive the LDM is capable of calculating the travel direction and speed of a pedestrian. In an alternative embodiment, the property information about the pedestrians 5_1-5_3 may be included as well. Meanwhile, the LDM need not include normally included map information (indicated by broken lines). While pedestrian information is dynamic map information, the map information is static map information. Therefore, the map information should be supplied from the traffic light 1 or other fixed roadside unit and added to the LDM or combined with map information possessed by a navigation system mounted in the vehicle (automobile) 4 that receives the map information.

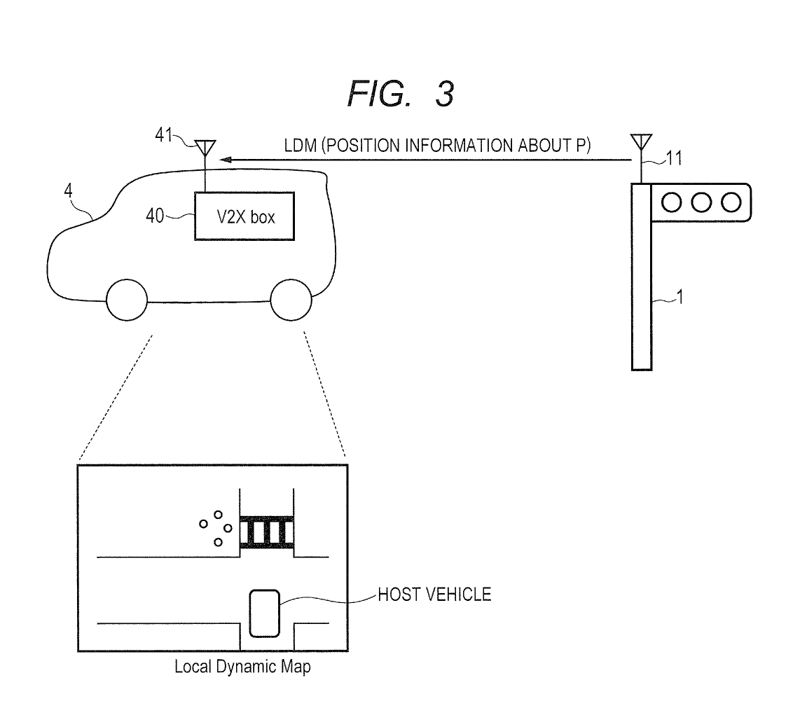

FIG. 3 is a schematic diagram illustrating an exemplary operation that is performed by the communication system to communicate with the vehicle (automobile). The V2X communication device (V2X box) 40 coupled to the antenna 41 is mounted in the vehicle 4 to establish V2X communication with the traffic light 1. The V2X communication is established to permit the vehicle 4 to receive the LDM including the position information about the pedestrians 5_1-5_3 from the traffic light 1. The vehicle 4 combines the map information and the position of the vehicle 4 with the received LDM to generate a final LDM. The map information may be acquired from a static map database possessed, for instance, by a navigation system mounted in the vehicle 4 or supplied from the ITS through the traffic light 1 or other roadside unit by using a service based on V2X communication. Although not shown, the position of the vehicle is acquired, for example, by a GPS (global positioning system) mounted in the vehicle.

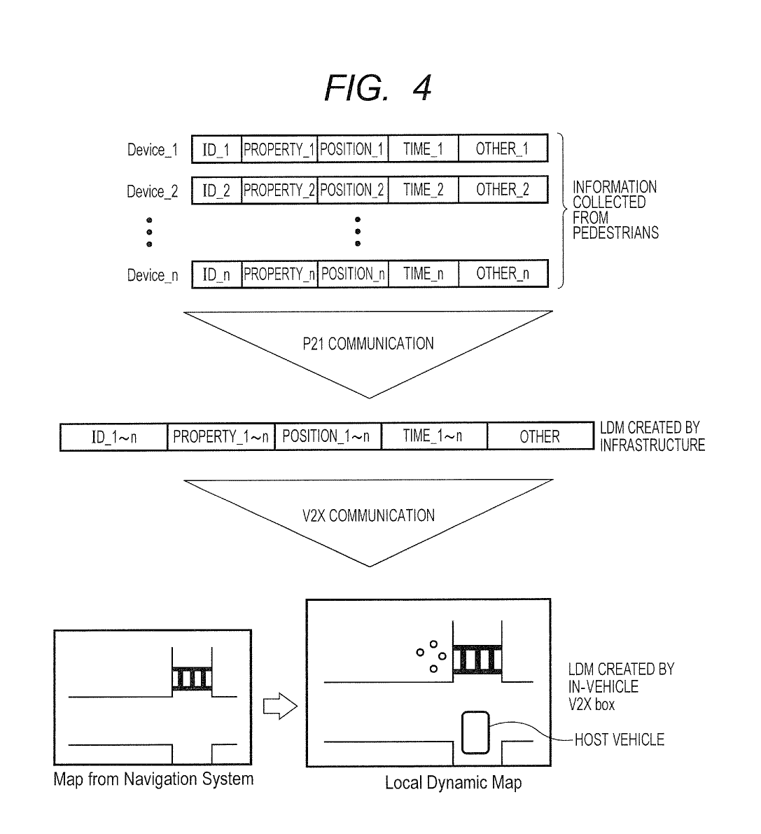

FIG. 4 is a diagram illustrating an exemplary operation that is performed by the communication system to create the map information (LDM). As illustrated in FIG. 2, the second communication device 2 included in the communication system 100 establishes P2I (person-to-infrastructure) communication collects information about individual pedestrians 5 through communication terminals Device_1-Device_n (communication terminals 50) carried by the pedestrians 5 (n persons). As mentioned earlier, the P2I communication is unicast or multicast communication such as wireless LAN (Wi-Fi) or Bluetooth communication. That is to say, the communication terminal Device_1 collects information about ID_1, property_1, position_1, time_1, and other_1 from one pedestrian, and the communication terminal Device_2 collects information about ID_2, property_2, position_2, time_2, and other_2 from another pedestrian. Similarly, the communication terminal Device_n collects information about ID_n, property_n, position_n, time_n, and other_n from the n-th pedestrian. The information about the ID, property, position, time, and other, which is indicated for each communication terminal (Device_1-Device_n), may be transmitted and received in the form of a single packet or separated into a plurality of packets before being transmitted and received. Alternatively, one packet may include a plurality of pieces of pedestrian information. When the communication terminals 50 carried by the pedestrians 5 have a relay function to perform, for example, multi-hopping, a relaying terminal adds its information to information about one or more trailing pedestrians and then transfers the resulting information. Therefore, there may be a case where one packet contains information about a plurality of pedestrians.

The pedestrian information including the collected position information about pedestrians is integrated as dynamic information about an LDM by the data processing device 3. The LDM into which the information about the pedestrians is integrated is transmitted to the vehicle 4 via V2X communication. That is to say, the LDM created by the infrastructure (data processing device 3) includes the whole information about all n pedestrians, namely, ID_1 to ID_n, property_1 to property_n, position_1 to position_n, and time_1 to time_n.

Upon receipt of the LDM including the pedestrian information from the infrastructure through the traffic light (roadside unit) 1, the vehicle 4 acquires static map information for integrating information into an LDM from, for example, a map database in a navigation system, and combines the acquired static map information, for example, with the position information about the pedestrians, which is included in the received LDM. The position information about the vehicle 4 should also be added to the combined information. This results in the generation of the LDM that is obtained by adding the information about the vehicle 4 and the information about the pedestrians to the map information. It is preferred, but not essential, that the LDM generated in the above manner be compliant with a Japanese institution, the EC (European Commission), the ISO (International Organization for Standardization), or other international organization.

The total amount of information about the individual pedestrians, which is transmitted from the communication terminals Device_1-Device_n (communication terminals 50) via P2I communication, is equal to the amount of information integrated and included in the LDM created by the infrastructure. The information about the individual pedestrians, which is transmitted from the communication terminals Device_1-Device_n (communication terminals 50), is formed of ID_1, property_1, position_1, and time_1, ID_2, property_2, position_2, and time_2, and so on to ID_n, property_n, position_n, and time_n. Therefore, the total amount of such information is equal to the amount of information included in the LDM created by the infrastructure, namely, the amount of information about ID_1-ID_n, property_1-property_n, position 1-position_n, and time_1-time_n. However, pieces of information are transmitted separately from the communication terminals Device_1-Device_n (communication terminals 50). Therefore, for example, encryption key information, signature, and certificate, need to be attached to each piece of information. Further, as communication is established by using a plurality of packets, a header compliant with an employed communication method needs to be attached to the information. Meanwhile, V2X communication is established in such a manner that one set of LDM information is merely transmitted from the infrastructure to the vehicle 4. Therefore, adding unique single encryption key information, signature, and certificate to a transmitting roadside unit (traffic light) 1 is adequate for the purpose. As a result, the amount of communication information transmitted via V2X communication can be made significantly smaller than the total amount of communication information transmitted via P1I communication. Further, even when a plurality of vehicles exist within the communication range from the roadside unit (traffic light) 1, broadcasting a single LDM to all vehicles is adequate for the purpose. Mapping, in each vehicle, for example, the position information about a required number of pedestrians and combining it with the map information about a host vehicle and about a required area around the host vehicle is adequate for the purpose. The integrated LDM can be displayed to a driver of a vehicle or utilized as basic information for predicting a hazard and preventing an accident. While the vehicle 4 is being automatically driven, the integrated LDM can be delivered to an artificial intelligence unit (cognitive unit) and utilized for vehicle control. Consequently, even when the same pedestrian information (LDM) is broadcast to a plurality of vehicles participating in road-to-vehicle communication, the positions of individual pedestrians can be mapped, in each vehicle, into map information based on the position of the host vehicle, recognized as having a relatively appropriate positional relationship to the host vehicle, and used effectively, for instance, to prevent accidents.

As described above, P2I communication by the unicast method or by the multicast method is suitable for collecting information about individual pedestrians. For V2X communication, the broadcast method is suitable because one infrastructure 1 simply has to simultaneously transmit single map information including the position information about the pedestrians as dynamic information to a plurality of vehicles.

Consequently, even when there are an enormous number of pedestrians 5, it is possible to build a communication system that is capable of preventing a disruption of broadcast-type V2X communication between the vehicle 4 and the roadside unit (traffic light) 1, which is an infrastructure.

The information collected from the pedestrians should preferably include unique IDs and time information in accordance with the position information. The IDs and time information are included in a consolidated LDM and transmitted to the vehicle 4. The vehicle 4 is capable of calculating the travel direction and speed of each pedestrian from position and time information. The travel direction and speed of each pedestrian included in the LDM need not necessarily be calculated. For example, the travel direction may be limited, for instance, to the travel direction of the host vehicle as needed. Alternatively, changes may be applied depending on the characteristics of the pedestrians, for instance, by giving priority to pedestrians traveling at an unexpected speed. This makes it possible to reduce the amount of computation performed in the V2X communication device (V2X box) 40 of the vehicle 4. Further, the roadside unit (traffic light) 1 needs to periodically collect the position information from the pedestrians. However, as the pedestrians travel at a significantly lower speed than automobiles, the intervals at which the position information is collected from the pedestrians can be longer than standard intervals of V2X. When the intervals at which the position information about the pedestrians is collected are increased, the collected position information can be transmitted at longer intervals. This makes it possible to reduce the traffic during P2I communication. Additionally, in the V2X communication device (V2X box) of the vehicle 4, too, the travel direction and speed of each pedestrian are calculated at longer intervals. This reduces the amount of computation. Meanwhile, shortening the intervals makes it possible to increase the accuracy of responding to an abrupt change in the direction of a pedestrian and to a pedestrian rushing out in front of a vehicle.

The information collected from a pedestrian further includes property information about the pedestrian. The property information about the pedestrian includes information for evaluating whether the pedestrian needs to be heavily protected for traffic safety, such as the information indicating whether the pedestrian is disabled, aged, infant, accompanied by children, pregnant, or otherwise disadvantaged. Priority is determined based on such property information so that appropriate measures can be taken for pedestrians having high priority in accordance with their properties. More specifically, for example, accentuated visual information can be presented to a driver of a vehicle to alert the driver to a condition requiring attention. For such purposes, for example, the travel direction and speed of a pedestrian can be preferentially calculated.

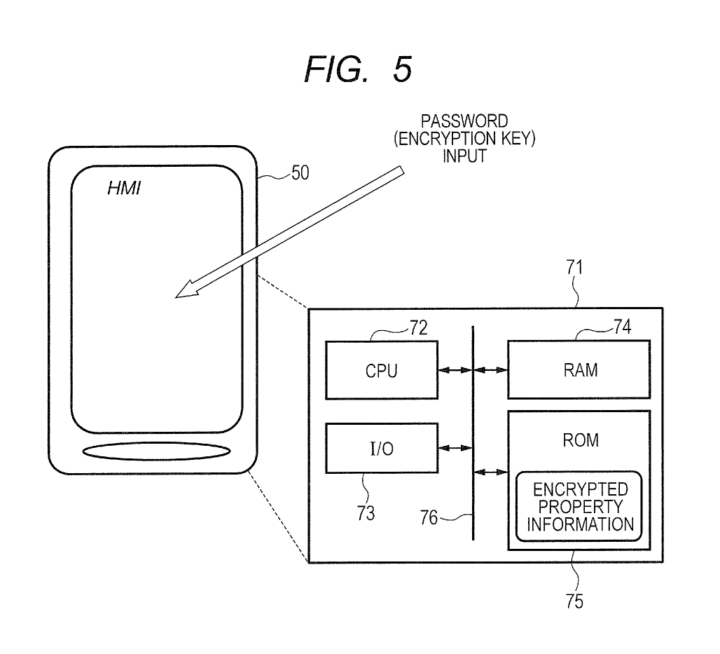

FIG. 5 is a diagram illustrating an exemplary configuration of the communication terminal 50 carried by a pedestrian 5 in the communication system. The communication terminal 50 carried by a pedestrian 5 should preferably be a communication terminal having a user interface (human-machine interface (HMI)), such as a smartphone or a mobile phone. The reason is that such a communication terminal is capable of displaying various information transmitted through a downlink from the communication system 100, such as later-described information about the approach or passage of an emergency vehicle and traffic information about restricted traffic and traffic congestion.

Although not shown, the communication terminal 50 has a wireless LAN (Wi-Fi), Bluetooth, or other communication function. Such a general-purpose communication device can be organically coupled to a V2X communication system in order to efficiently collect an enormous amount of pedestrian information.

One purpose of the communication system is to provide assistance to pedestrians. Therefore, even when a pedestrian is healthy, the property information about the pedestrian, which is stored in the communication terminal 50 carried by the pedestrian, is a valuable asset used to provide highly convenient assistance services. However, providing equal assistance to all pedestrians is not efficient from the viewpoint of the effect of traffic. Consequently, it can be said that the property information is a more important asset that needs to be safely protected.

A semiconductor device, such as a secure microcomputer 71, is incorporated in the communication terminal 50. The property information is stored in a storage device (memory) in the semiconductor device. The property information should preferably be encrypted before being stored because it needs to be concealed for the aforementioned reason. The secure microcomputer 71 depicted in FIG. 5 is an exemplary means of concealing the property information. The secure microcomputer 71 is formed, for example, of a CPU 72, an I/O interface 73, a RAM (random-access memory) 74, and a ROM (read-only memory) 75, which are interconnected through a bus 76. The ROM 75 stores encrypted property information about a pedestrian. The ROM 75 may not only store the encrypted property information but may also be tamper-proof to deny extraneous access to a part or whole of the ROM 75. The property information to be concealed is password encrypted. When a user enters a password, which is an encryption key, from the HMI during a startup sequence of the communication device 50 or other device, the property information stored in the ROM 75 is decrypted and validated. When such a scheme is incorporated, the property information is kept secret.

It is preferred that the communication terminal 50 carried by a pedestrian 5 be a smartphone, a child abduction prevention device, or other device having a related-art communication function and an HMI. However, the communication terminal 50 need not necessarily include an HMI having a display function. The communication terminal 50 may alternatively be adapted to generate a voice message or emit a warning sound in accordance with information received through the downlink to alert the user to a condition requiring attention. Another alternative is to use a communication terminal 50 that is without an HMI and exclusively designed to transmit the position information and property information about the pedestrian to the communication system. That is to say, the communication terminal demanded here should have a function of responding to an inquiry from the communication system 100 by returning at least some of the ID, position information, property information, and time information about the pedestrian. The communication terminal may be built in a cane, a baby carriage, a walking assist device, or other device constantly carried by the pedestrian. It is important that the communication terminal be constantly carried by the user who is a pedestrian. In general, children and aged people account for a large percentage of traffic accident victims. It is therefore preferred that the communication terminal be a device constantly carried by people of such generations.

The first embodiment has been described on the assumption that a V2X communication system is used. However, the first embodiment is not only applicable to the V2X communication system, but also commonly applicable to all communication systems that employ a broadcast-type or other similar communication method. In short, the communication system includes a first communication device (for example, the roadside unit 1), the second communication device 2, and the data processing device 3.

The first communication device (for example, the roadside unit 1) establishes broadcast-type first communication (for example, V2X communication) with a first communication terminal (for example, the vehicle 4). The second communication device 2 establishes unicast- or multicast-type second communication with a plurality of moving objects (for example, the pedestrians 5) other than the first communication terminal and acquires the position information about the moving objects. The data processing device 3 operates in such a manner that information (for example, an LDM) obtained by integrating a plurality of pieces of position information about the moving objects, which are acquired by the second communication device 2, is transmitted from the first communication device (for example, the roadside unit 1) to the first communication terminal (for example, the vehicle 4).

Consequently, even when there are an enormous number of moving objects, it is possible to prevent a disruption of broadcast-type first communication between the first communication device and the first communication terminal. That is to say, the similar problem can be solved.

### Second Embodiment

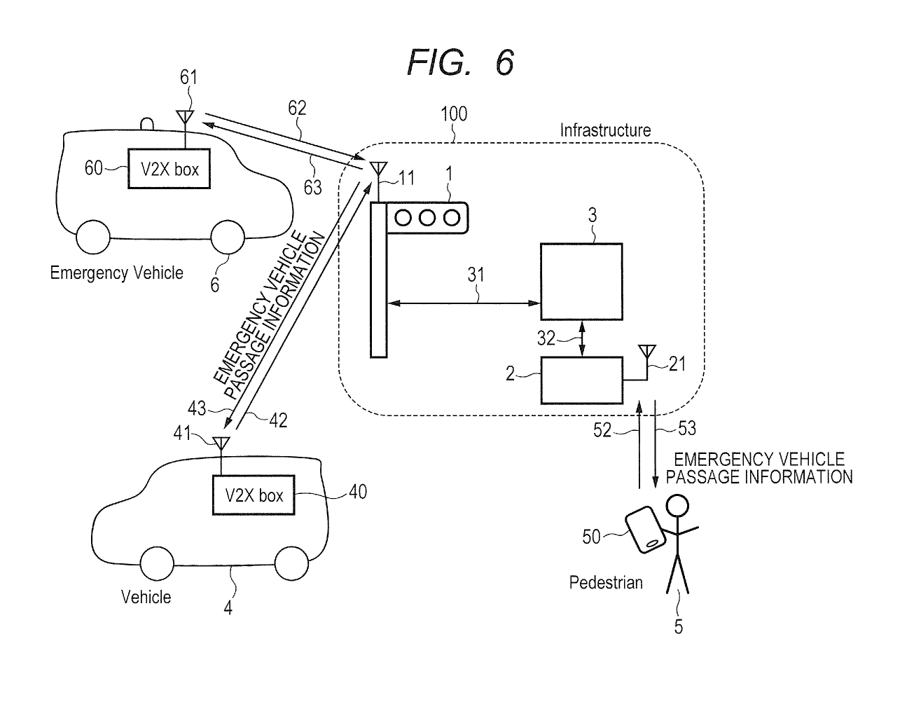

FIG. 6 is a diagram illustrating an exemplary overall operation that is performed by the communication system when an emergency vehicle 6 passes through an intersection in the communication system. The emergency vehicle 6 is added to the communication system depicted in FIG. 1. The emergency vehicle 6 is a kind of the vehicle 4. In a second embodiment of the present invention, however, the reference numeral 6, which is different from that of the vehicle 4, is added to the emergency vehicle to distinguish it from a general vehicle 4. A V2X communication device (V2X box) 60, which is coupled to an antenna 61, is also mounted in the emergency vehicle 6 to establish V2X communication with the traffic light (roadside unit) 1. The reference numeral 62 denotes an uplink, and the reference numeral 63 denotes a downlink. When the emergency vehicle 6 is about to pass through the intersection, the emergency vehicle 6 uses the uplink 62 for V2X communication to notify the roadside unit (traffic light 1) of an approaching emergency vehicle. In response to such a notification, the roadside unit (traffic light 1) delivers attention-calling information to the general vehicle 4 through a downlink 43 for V2X communication in order to notify that an emergency vehicle is about to pass. Additionally, the second communication device 2 delivers similar attention-calling information to a pedestrian 5 through a downlink 53 to notify that an emergency vehicle is about to pass. The other elements and operations are the same as described in conjunction with the first embodiment, which has been described with reference to FIGS. 1 to 5, and will not be redundantly described.

In use cases of the V2X communication system, the efficiency of traffic is increased generally by controlling traffic lights in accordance with information about vehicles (automobiles, motorbikes, and bicycles), infrastructures, and pedestrians. More specifically, when no vehicle or pedestrian is waiting at an intersection for a traffic light change, the traffic light maintains its current state (for example, keeps the green light illuminated) because there is no need to change the color of the traffic light. When there is a pedestrian, priority may be basically given to the pedestrian although it may depend on the culture and customs of a country or region. Meanwhile, when an emergency vehicle, such as an ambulance or a police car, approaches an intersection, priority may be given to the passage of the emergency vehicle. From high to low, priorities on passage are given to emergency vehicles, vulnerable road users, general pedestrians, and general vehicles in the order named. Such priorities are defined according to laws and regulations while considering the culture and customs of a country or region. Here, the vulnerable road users denote pedestrians to be heavily protected for traffic safety, such as those disabled, aged, infant, accompanied by children, or pregnant.

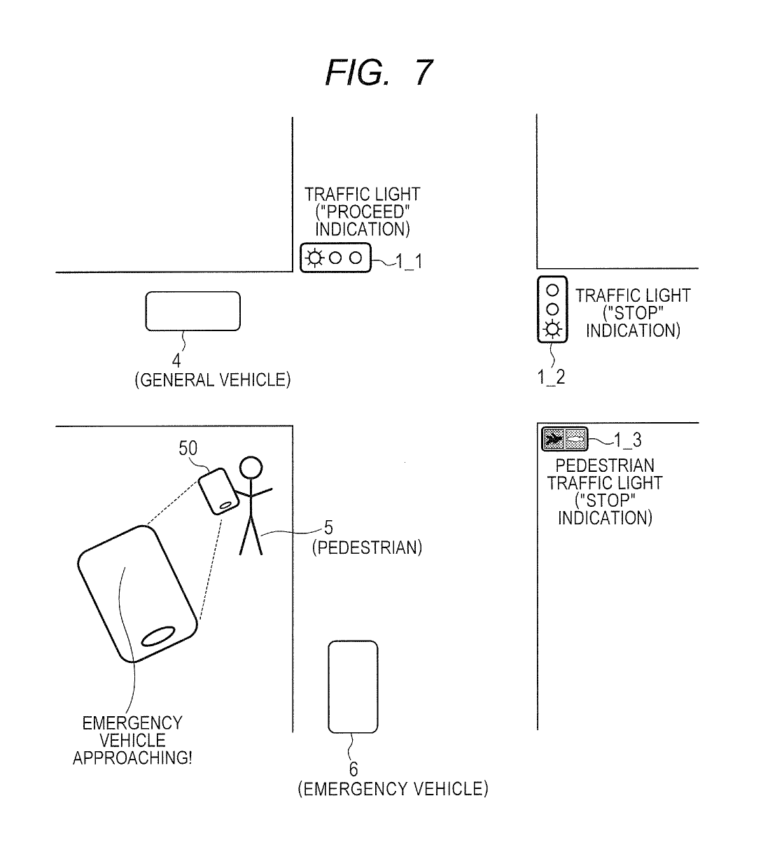

FIG. 7 is a schematic diagram illustrating an exemplary operation that is performed by the communication system when the emergency vehicle 6 approaches an intersection. When the emergency vehicle 6 is approaching the intersection, a traffic light 1_1 for traveling direction turns green to start traffic, and a traffic light 1_2 and a pedestrian traffic light 1_3 for intersecting direction turn red to stop traffic. Additionally, the pedestrian 5 is notified of the approaching emergency vehicle 6 by displaying the message “Emergency Vehicle Approaching!”, for instance, on the communication terminal 50 carried by the pedestrian 5. No matter whether the communication terminal 50 has a display function, a warning may be issued to the pedestrian 5 by using an alternative or additional means, for example, of vibrating or generating a voice message or a warning sound. Relevant information is displayed or transmitted to the general vehicle 4 in compliance with common specifications for a V2X system. In this instance, the time required for a change in the color of the traffic light may be calculated, for instance, from information about the position and speed of the emergency vehicle 6 and displayed to the V2X communication device (V2X box) 40 or other device mounted in the general vehicle 4 and to the communication terminal carried by the pedestrian 5. Using such a scheme makes it possible to safely notify the pedestrian 5 of an approaching emergency vehicle 6 without interrupting the travel of the emergency vehicle 6.

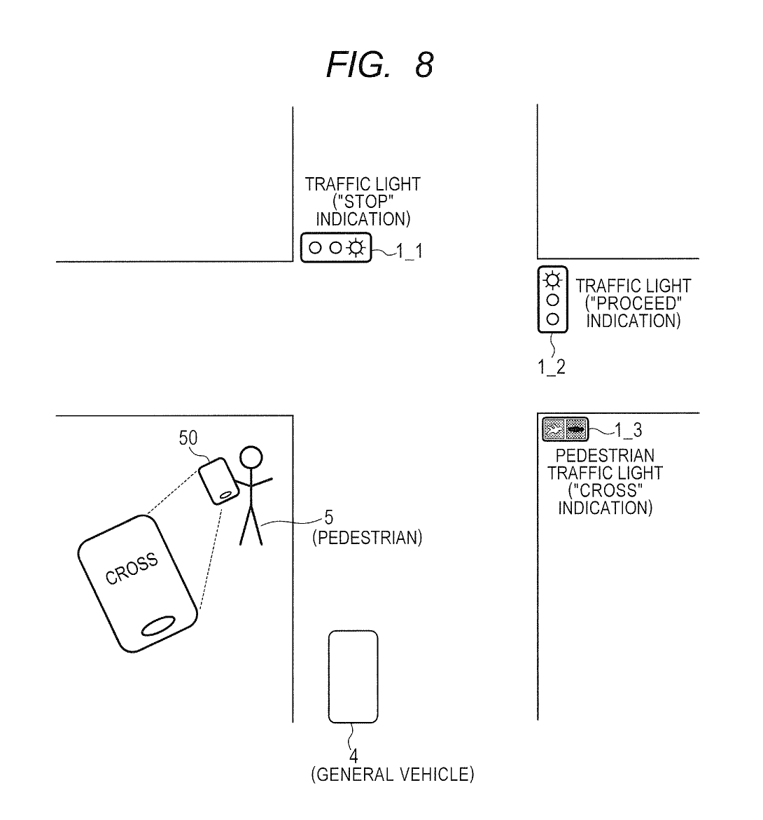

Meanwhile, FIG. 8 is a schematic diagram illustrating an exemplary operation that is performed by the communication system in a normal state where no emergency vehicle 6 is passing. As described in conjunction with the first embodiment, the roadside unit (traffic light) 1 is capable of collecting property information about surrounding pedestrians 5 in addition to their position information. The LDM based on the collected position information and property information is additionally used in the second embodiment for the control of the traffic light although the first embodiment is described on the assumption that the LDM is transmitted to the vehicle 4. Priorities of the pedestrians can be determined from the collected property information in order to control the traffic light in accordance with the determined priorities. When, for instance, the priorities exemplified earlier are followed, priority is given to a crossing pedestrian (vulnerable road user) who has the highest priority after the emergency vehicle 6. In this instance, as exemplified in FIG. 8, the traffic light for the general vehicle 4 turns red to stop traffic, and the pedestrian traffic light 1_3 for traveling direction of the pedestrian 5 turns green to start traffic. Additionally, the message “Crossing Allowed” is displayed to the communication terminal 50 carried by the pedestrian 5 in order to notify that the pedestrian 5 can safely cross an intersection. Further, green light illumination time and remaining green light illumination time can be displayed as well. Furthermore, when the pedestrian is a vulnerable road user having a particularly high priority, switching can be made to control the traffic light in an appropriate manner. When, for instance, a vulnerable road user is about to cross an intersection, the probability of accident occurrence can be reduced by causing the traffic light to turn red for vehicles traveling in a crossing direction and for vehicles traveling in the same direction as the vulnerable road user and trying to turn left or right.

### Third Embodiment

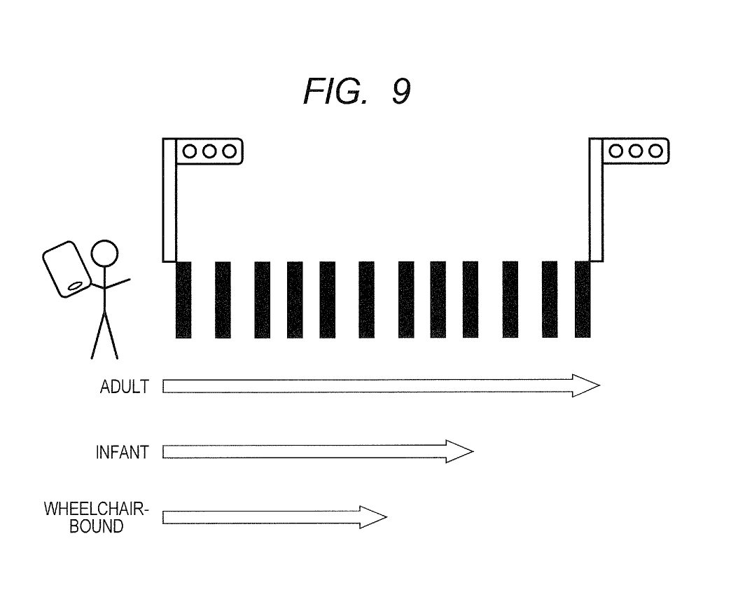

FIG. 9 is a schematic diagram illustrating that crossing time varies with the properties of pedestrians. FIG. 9 schematically exemplifies the distances that can be walked in a predetermined period of time respectively by adult, infant, and wheelchair-bound pedestrians. The adult pedestrian can walk the longest distance. The infant pedestrian can walk the second longest distance. The wheelchair-bound pedestrian can walk the shortest distance. As described above, the distance that can be walked in a predetermined period of time varies from one pedestrian to another. If a pedestrian cannot walk through a crosswalk within a predetermined period of time, the pedestrian is urged to go at a run. This creates an unsafe traffic situation.

A third embodiment of the present invention will be described with reference to various forms in which the communication system assists a pedestrian in safely crossing an intersection.

When a predetermined priority level is exceeded by the property information about a pedestrian 5, which is collected by the second communication device 2, the communication system depicted in FIG. 1 calculates the travel direction of the pedestrian from the position information about time information about the pedestrian and controls the indication of a traffic light positioned in the calculated travel direction.

Consequently, traffic light control can be exercised to ensure that the pedestrian having a property beyond the predetermined priority level safely crosses an intersection.

As an example of the above one form, a case where the start and completion of a pedestrian's crossing are detected will be described below.

FIG. 10 is a schematic diagram illustrating an exemplary embodiment that detects the start and completion of a pedestrian's crossing.

A traffic light 1_1 is at an end at which a pedestrian 5 starts crossing. A traffic light 1-2 is at another end at which the pedestrian 5 completes crossing. Second communication devices 2_1, 2_2 (not shown) coupled respectively to the traffic lights 1_1, 1_2 communicate with the pedestrian 5 (or, more precisely, the communication terminal 50 carried by the pedestrian 5). When the communication distance between the second communication device 2_1 and the communication terminal 50 and the communication distance between the second communication device 2_2 and the communication terminal 50 are properly set, the start and completion of a pedestrian's crossing can be detected. For example, the communication distance between the second communication device 2_1 and the communication terminal 50 and the communication distance between the second communication device 2_2 and the communication terminal 50 are respectively set in such a manner that the communication distances are long enough to establish communication while the pedestrian is waiting for a change in the color of a traffic light and sufficiently shorter than the distance to be crossed by the pedestrian. This ensures that the communication between the second communication device 2_1 and the communication terminal 50 ends immediately after the pedestrian 5 starts crossing, and that the communication between the second communication device 2_2 and the communication terminal 50 starts when the pedestrian 5 completes crossing. As described above, the second communication device 2_1 can detect the start of the pedestrian's crossing, and the second communication device 2-2 can detect the completion of the pedestrian's crossing. Thus, the traffic light for the pedestrian 5 can be maintained in its green state between the start and completion of the pedestrian's crossing in order to permit the pedestrian 5 to cross safely. When the detection is based on the start and end of communication, a significant error may occur. However, the error can be more or less absorbed by adding an appropriate margin in consideration of the communication distance. If, in this instance, the pedestrian 5 crosses in a direction different from the calculated travel direction, the completion of crossing may not be detected after the detection of the start of crossing. Therefore, the upper limit of time for reconnection may be set, and if the upper limit is exceeded, the start of crossing may be invalidated to revert to a normal traffic light operation. An alternative is to switch to a detection scheme based, for instance, on an acceleration sensor built in the communication terminal 50 or use such a detection scheme in coordination with the above-described one. Another alternative is to let the pedestrian enter relevant information through the HMI of the communication terminal 50 in order to transmit the entered relevant information to the second communication devices 2_1, 2_2.

Instead of the above-described control scheme based on the actual start and completion of crossing, a statistical control scheme may be employed. More specifically, the period during which the traffic light 1_2 positioned in the travel direction of the pedestrian 5 glows green to permit the pedestrian 5 to cross is extended based on the property information about the pedestrian 5. This makes it possible to provide the pedestrian with adequate crossing time without exercising complicated control.

The present embodiment may be further modified in such a manner that the property information and position information about a pedestrian are transferred between traffic lights to exercise traffic light control in accordance with a predicted path of the pedestrian.

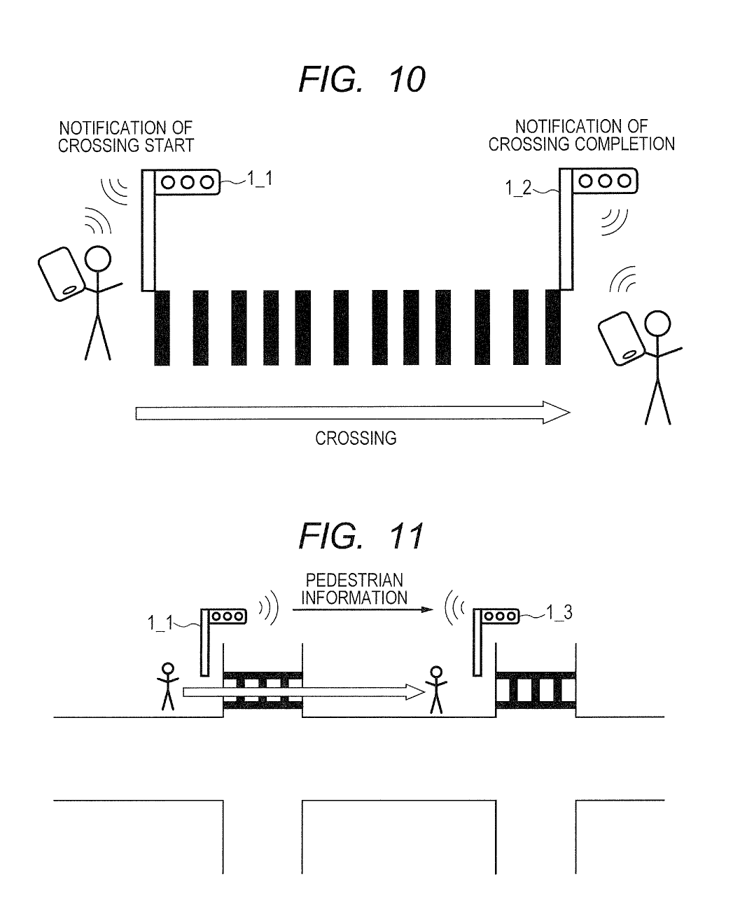

FIG. 11 is a schematic diagram illustrating an exemplary embodiment that transfers information about a pedestrian from one roadside unit to another. Traffic lights 1_1, 1_3 are not positioned at the near and far ends of a crosswalk as indicated in FIG. 10. The traffic light 1-1 is for one intersection, and the traffic light 1_3 is for the next intersection. The traffic light 1_1 (or, more precisely, the infrastructure including the second communication device 2_1 and data processing device 3_1 (not shown) coupled to the traffic light 1_1) communicates with the pedestrian 5 to acquire the position information and property information about the pedestrian 5, then calculates the travel direction and speed of the pedestrian 5, and transfers the property information and other relevant information about the pedestrian 5 to the traffic light 1_3 positioned in the travel direction of the pedestrian 5.

Consequently, a series of coordinated traffic control operations can be performed, for instance, by controlling the next traffic light positioned in the travel direction of the pedestrian in coordination with the control over the traffic light currently used for crossing. However, the traffic light 1_1 and the traffic light 1_3 are not limited to traffic lights installed at an intersection, but may be, for example, roadside units other than traffic lights.

While the present invention made by its inventors has been described in detail with reference to embodiments, the present invention is not limited to the embodiments. It is to be understood by those skilled in the art that various modifications can be made without departing from the spirit and scope of the present invention.

For example, the foregoing embodiments have been described with reference to a case where the V2X communication between pedestrians and an infrastructure (roadside unit) in a V2X communication system is substituted by another communication (Wi-Fi or Bluetooth communication). However, when the number of pedestrians is sufficiently small, the V2X communication system may be configured in such a manner that direct V2X communication is established between the pedestrians and the infrastructure (roadside unit) and between the pedestrians and vehicles (automobiles).

What is claimed is:

1. A data processing device capable of:
communicating with a first communication device that is capable of establishing broadcast-type first communication with a first communication terminal;
communicating with a second communication device that is capable of establishing unicast- or multicast-type second communication with a plurality of moving objects other than the first communication terminal and acquiring position information about the moving objects; and
causing the second communication device to acquire a plurality of pieces of position information about the moving objects and causing the first communication device to transmit integrated information to the first communication terminal, the integrated information being obtained by integrating the acquired pieces of position information into a single piece of information.

2. The data processing device according to claim 1,
wherein the data processing device is capable of causing the second communication device to acquire identification information about each of the moving objects and time information associated with the position information, add the acquired identification information and time information to the integrated information, and transmit the resulting information from the first communication device to the first communication terminal.

3. The data processing device according to claim 2,
wherein the data processing device is capable of causing the second communication device to further acquire property information about each of the moving objects, add the acquired property information to the integrated information, and transmit the resulting information from the first communication device to the first communication terminal.

4. The data processing device according to claim 1,
wherein the first communication terminal is a vehicle having a communication device for establishing the first communication;
wherein the first communication is vehicle-to-vehicle and road-to-vehicle communication;
wherein the first communication device is a roadside unit;
wherein the moving objects are pedestrians carrying a communication device for establishing the second communication; and
wherein the integrated information obtained from the pieces of position information is a map including position information about the pedestrians.

5. The data processing device according to claim 4,
wherein the second communication is public wireless LAN or Bluetooth communication.

6. A data processing device capable of:
communicating with a first communication device that is capable of establishing broadcast-type first communication with a first communication terminal;
communicating with a second communication device that is capable of establishing unicast- or multicast-type second communication with a plurality of moving objects other than the first communication terminal and acquiring position information about the moving objects; and
causing the second communication device to acquire a plurality of pieces of property information about the moving objects in order to
permit the first communication device to transmit integrated information to the first communication terminal, the integrated information being obtained by integrating the acquired pieces of property information into a single piece of information, or
control a device coupled to the first communication device in accordance with the acquired pieces of property information.

7. The data processing device according to claim 6,
wherein the first communication terminal is a vehicle having a communication device for establishing the first communication;
wherein the first communication is vehicle-to-vehicle and road-to-vehicle communication;
wherein the first communication device is a roadside unit;
wherein the moving objects are pedestrians carrying a communication device for establishing the second communication; and
wherein the second communication is public wireless LAN or Bluetooth communication.

8. The data processing device according to claim 7,
wherein the first communication terminal includes a general vehicle and an emergency vehicle;
wherein the first communication device is coupled to a traffic light; and
wherein, when the first communication device detects that the emergency vehicle is approaching, the traffic light is controlled to give priority to the passage of the emergency vehicle.

9. The data processing device according to claim 7,
wherein, when the first communication device detects that the emergency vehicle is approaching, the first communication is established to transmit information about the passage of the emergency vehicle to the general vehicle through the roadside unit, and the second communication is established to transmit information about the passage of the emergency vehicle to the pedestrians through the second communication device.

10. The data processing device according to claim 7,
wherein the first communication device is coupled to a traffic light; and
wherein, when a predetermined priority level is exceeded by property information about a pedestrian, the travel direction of the pedestrian is calculated from position information and time information about the pedestrian in order to control the indication of a traffic light positioned in the travel direction, the property information being acquired by the second communication device, the position information and the time information being additionally acquired by the second communication device.

11. The data processing device according to claim 10,
wherein, in accordance with the property information about the pedestrian, the traffic light positioned in the travel direction of the pedestrian extends a period of time during which an indication is given to permit the pedestrian to cross.

12. The data processing device according to claim 10,
wherein one of a plurality of units of the second communication device is a third communication device installed at a near end of a crosswalk positioned in the travel direction of the pedestrian, and the other unit of the second communication device is a fourth communication device installed at a far end of the crosswalk; and
wherein a communication device carried by the pedestrian communicates with the third communication device to detect that the pedestrian has started crossing the crosswalk, and the communication device carried by the pedestrian communicates with the fourth communication device to detect that the pedestrian has completed crossing the crosswalk.

13. The data processing device according to claim 7,
wherein the second communication device is caused to further acquire identification information about each of the pedestrians, position information, and time information associated with the position information; and
wherein the device coupled to the first communication device is controlled by causing the roadside unit to further add acquired pieces of property information to the integrated information and transmit the resulting information to the vehicle or is controlled in accordance with the property information, the identification information, the position information, and the time information.

14. The data processing device according to claim 13,
wherein the travel direction and speed of at least one of the pedestrians are calculated in accordance with the acquired identification information, the acquired position information, and the acquired time information.

15. The data processing device according to claim 13,
wherein the identification information, the position information, the time information, and the property information are transferred to the next roadside unit positioned in the travel direction of the pedestrian, the identification information, the position information, the time information, and the property information being acquired from the pedestrian.

16. An in-vehicle communication device capable of establishing broadcast-type road-to-vehicle communication with a roadside unit included in a communication system,
wherein the communication system includes a second communication device that is capable of establishing unicast- or multicast-type second communication with a plurality of pedestrians and acquiring position information about the pedestrians; and
wherein the position information about the pedestrians that is acquired by the second communication device is integrated into a single piece of information and received from the roadside unit.

17. The in-vehicle communication device according to claim 16,
wherein the in-vehicle communication device extracts position information about the pedestrians from the information received from the roadside unit and combines the extracted position information with map information about the vicinity of a vehicle in which the in-vehicle communication device is mounted.

18. The in-vehicle communication device according to claim 17,
wherein the communication system causes the second communication device to further acquire identification information about each of the pedestrians and time information associated with the position information;
wherein the information that the in-vehicle communication device receives from the roadside unit further includes the identification information and the time information, which are acquired by the second communication device; and
wherein, from position information and time information about at least one of a plurality of pedestrians, which are extracted from the information received from the roadside unit, the in-vehicle communication device calculates the travel direction and speed of the pedestrian.

19. The in-vehicle communication device according to claim 17,
wherein the communication system causes the second communication device to further acquire property information about each of the pedestrians;
wherein the information that the in-vehicle communication device receives from the roadside unit further includes the property information acquired by the second communication device; and
wherein the in-vehicle communication device adds property information about at least one of the pedestrians to the map information, the property information being extracted from the information received from the roadside unit.
